(19) United States
(12) Patent Application Publication
(10) Pub. No.: US 2020/0147534 A1
(43) Pub. Date: May 14, 2020

(54) High Flow Rate Sock Filter

(71) Applicants: John Jay Johnston, (US); Susan Diane Johnston, (US)

(72) Inventors: John Jay Johnston, Albuquerque, NM (US); Susan Diane Johnston, Albuquerque, NM (US)

(73) Assignees: John Jay Johnston, Albuquerque, NM (US); Susan Diane Johnston, Albuquerque, NM (US)

(21) Appl. No.: 16/184,573

(22) Filed: Nov. 8, 2018

(51) Int. Cl. B01D 39/16; B01D 39/08; B01D 46/02; B01D 29/11; B01D 29/15; B01D 29/52

(52) U.S. Cl. CPC B01D 39/1623; B01D 39/083; B01D 29/52; B01D 29/111; B01D 29/15; B01D 46/02

(57) ABSTRACT

A filter system for filtering a fluid is disclosed which consists of a sock filter for use in a pool containing a high flow rate laminar flow current generator. The sock filter separates particles of a certain size from an unclean fluid. The unclean fluid is contained within a pool with a high flow rate laminar flow generator used to create laminar flow. Pools containing high flow rate laminar flow generators contain only low flow rate skimmer paper filters and do not contain floor drains and suction ports for removing settled particles. The High Flow Rate Sock Filter attaches to the high flow rate laminar flow generator and filters particles from the fluid within the pool. The sock filter can be detached for rinsing and cleaning.

### DETAILED DESCRIPTION OF THE INVENTION

A perspective view the High Flow Rate Sock Filter fully assembled is shown in FIG. 1. All shaded areas are made of 100 Percent Polyester Monofilament Mesh, 300 threads per inch, tensile strength 30 Newtons/Centimeters, 45 micron opening size (aperture), opening percentage 30 percent/ratio of surface area. Double lines represent woven rayon binding that is sewn with a zig-zag stitch over the seams that join the sides together.

Reference 10 designates the top long panel of the High Flow Rate Sock Filter Sock Filter.

Reference 10A designates the right long side panel of the High Flow Rate Sock Filter.

Reference 10B designates the bottom long panel of the High Flow Rate Sock Filter.

Reference 10C designates the left long side panel of the High Flow Rate Sock Filter.

The length of each long side, References 10, 10A, 10B, and 10C, is 48 inches (121.92 cm). The length of the 2 short sides (ends) of References 10, 10A, 10B, and 10c is 20 inches (50.8 cm).

Reference 10, top long panel, is sewn to Reference 10A, right long side panel, at Reference 10, top long panel's right long edge and Reference 10A right long side panel's top long edge creating 2 perpendicular sides.

Reference 10A, right long side panel, is sewn to Reference 10B, bottom long panel, at Reference 10A, right long side panel's bottom long edge and Reference 10B, bottom long panel's right long edge creating a 3 sided perpendicular shape with an open left side.

Reference 10B, bottom long panel, is sewn to Reference 10C, left long side panel, at Reference 10B, bottom long panel's left long edge and Reference 10C, left long side panel's bottom long edge.

Reference 10C, left long side panel, is sewn to Reference 10, top long panel, at Reference 10C, left long side panel's top long edge and Reference 10, top long panel's left long edge creating a rectangular shape with 2 open ends.

Reference 20 designates the closed bottom square panel of the High Flow Rate Sock Filter.

The closed bottom measures 20 inches (50.8 cm) on all 4 sides and is sewn to the rear ends of the 4 peripheral long panels to create a closed bottom rectangular box shaped sock filter with an opposing open top.

All seams adjoining the closed bottom to the 4 peripheral long panels are reinforced by woven rayon binding sewn with a zig zag stitch over the adjoining seams.

All shaded areas of the closed bottom are made of 100 Percent Polyester Monofilament Mesh, 300 threads per inch, tensile strength 30 Newtons/Centimeters, 45 micron opening size (aperture), opening percentage 30 percent/ratio of surface area

Reference 30 designates the open square top of the High Flow Rate Sock Filter. The open square top does not contain monofilament mesh, it is open, and is constructed of woven rayon binding represented by double lines sewn over the adjoining front edges of the 4 perpendicular long sides.

References 40, 40A, 40B, and 400 designate 4 male metal snaps that are affixed to the four corners of Reference 30, open square top.

Reference 40 designates the top left male metal snap, that is affixed to the woven rayon binding. Reference 40, top left male metal snap, affixes to corresponding left female snap mounted on the high flow rate laminar flow generator within a pool.

Reference 40A designates the top right male metal snap, that is affixed to the woven rayon binding. Reference 40A, top right male metal snap, affixes to corresponding top right female snap mounted on the high flow rate laminar flow generator within a pool.

Reference 40B designates the bottom right male metal snap, that is affixed to the woven rayon binding. Reference 40B, bottom right male metal snap, affixes to corresponding bottom right female snap mounted on the high flow rate laminar flow generator within a pool.

Reference 400 designates the top right male metal snap, that is affixed to the woven rayon binding. Reference 40C, top right male metal snap, affixes to corresponding top right female snap mounted on the high flow rate laminar flow generator within a pool.

Reference 50 designates the woven rayon binding oversewn on all adjoining assembly seams to reinforce and add structure and strength to the High Flow Rate Sock Filter.

FIG. 3 is an exploded view of all component pieces used to construct the High Flow Rate Sock Filter.

All shaded areas are made of 100 Percent Polyester Monofilament Mesh, 300 threads per inch, tensile strength 30 Newtons/Centimeters, 45 micron opening size (aperture), opening percentage 30 percent/ratio of surface area.

References 10, 10A, 10B and 10C denote the 4 long perpendicular panels used to assemble the long sides of the High Flow Rate Sock Filter into a rectangular shape.

Reference 20 denotes the closed square bottom of the High Flow Rate Sock Filter. The 4 edges of Reference 20, closed square bottom, are sewn to the rear of the rectangular box shape created by the 4 joined long sides, References 10, 10A, 10B, and 10C, creating a closed bottom.

Reference 30 denotes the open square top of the High Flow Rate Sock Filter. The open square top does not contain monofilament mesh, it is open, and is constructed of woven rayon binding represented by double lines sewn over the adjoining front edges of the 4 perpendicular long sides.

References 40, 40A, 40B, and 400 designate 4 male metal snaps that are affixed to the four corners of Reference 30, open square top.

Reference 40 denotes the 4 male metal snaps.

Male snap attachments are of a non corrosive metal

Reference 50 denotes the woven rayon binding that is sewn along all adjoining seams of the High Flow Rate Sock Filter and the front edges of the 4 perpendicular long sides to form the open top of the High Flow Rate Sock Filter. Binding is made of woven rayon.

### BRIEF DESCRIPTION OF THE DRAWINGS

FIG. 1 is a perspective view of the High Flow Rate Pool Sock Filter fully assembled. The shaded portion is made of 100 Percent PolyesterMonofilament Mesh, 300 threads per inch, tensile strength 30 Newtons/Centimeters, 45 micron opening size (aperture), open percentage 30 percent/ratio of surface area.

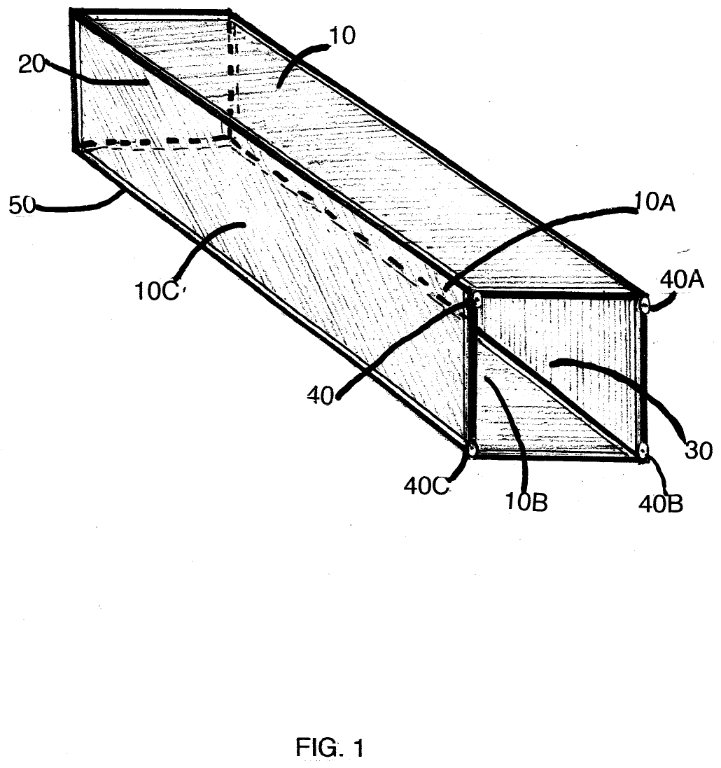

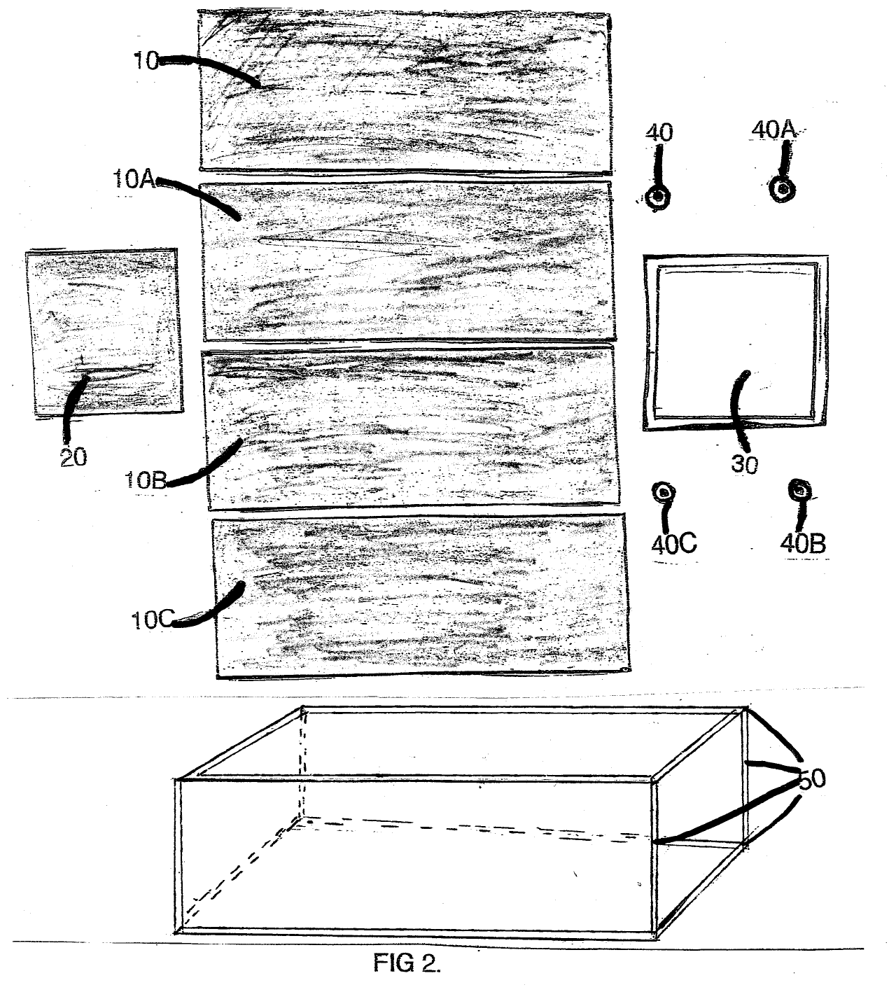

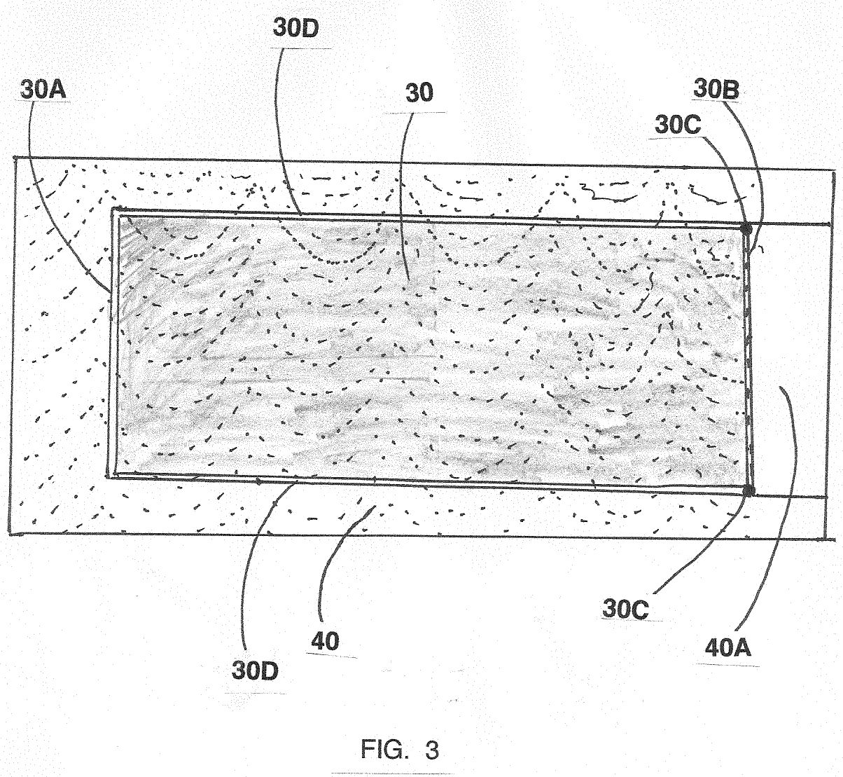

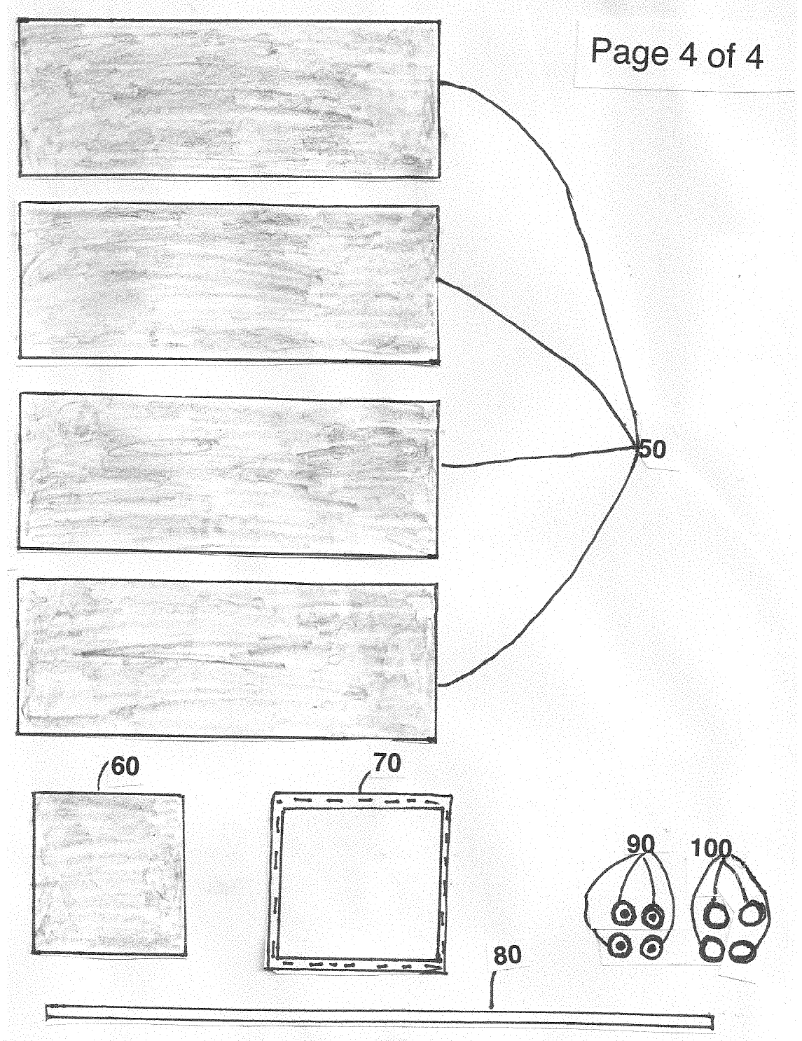

References 10, 10A, 10B, and 10C are 4 side panels sewn together at top and bottom long edges to form a rectangular shape with an open bottom and an open top.

The open bottom, is enclosed by sewing a square bottom panel, Reference 20, to one end of the assembled rectangular shape of References 10, 10A 10B, and 10C. The Square bottom panel is made of 100 Percent Polyester Monofilament Mesh, 300 threads per inch, tensile strength 30 Newtons/Centimeters, 45 micron opening size (aperture), opening percentage 30 percent/ratio of surface area.

The open top formed by the assembled rectangular shape, References 10, 10 A, 10B, and 10C is not enclosed.

The open square top, Reference 30, is formed by woven rayon binding sewn over the open top raw edges of the assembled rectangular shape formed by References 10, 10A, 10B, and 10C.

Reference 50 designates the woven rayon binding. The woven rayon binding reinforces and adds structure and strength to the High Flow Rate Sock Filter. Woven rayon binding is represented by double lines which cover all outside edges/seams of the High Flow Rate Sock Filter.

FIG. 3 is an exploded view of the component pieces to construct the High Flow Rate Sock Filter.

All shaded areas are made of 100 Percent Polyester Monofilament Mesh, 300 threads per inch, tensile strength 30 Newtons/Centimeters, 45 micron opening size (aperture), opening percentage 30 percent/ratio of surface area.

References 10, 10A, 10B and 10C, designate the 4 side panels sewn together at top and bottom long edges to form a rectangular shape with an open bottom and an open top.

Reference 20 designates the square bottom panel that is sewn to the back of the assembled 4 side panels to enclose the back side of the High Flow Rate Sock Filter.

Reference 30 designates the open square top, formed by woven rayon binding sewn over the open top raw edges of the assembled rectangular shape formed by References 10, 10A, 10B, and 100 and Reference 20.

References 40, 40A, 40B, and 40C designate 4 male metal snaps incorporated at each corner of the open square top. The 4 male metal snaps, References 40, 40A, 40B, and 40C, attach to 4 mounted female snaps located in corresponding positions on the high flow rate laminar flow generator within the swimming pool.

Male and female snap attachments are made of a non corrosive metal.

Reference 50 designates the woven rayon binding which covers all outside edges/seams and forms the open square top. and forms the open square top, Reference 30. Woven rayon binding is represented by double lines and reinforces and adds structure and strength to the High Flow Rate Sock Filter

I claim:

1. A filter system for a fluid, comprising a sock filter having 4 perpendicular side walls, one open top wall with snap attachments, and a closed bottom wall connected to said 4 perpendicular walls to form an enclosure, said open top wall contains 4 corner snaps to connect to high flow rate laminar generator placed in a container holding a large quantity of fluid, said sock filter expands during high flow rate laminar generation in said container routing unclean fluid through said sock filter, said sock filter traps particles filtering from said container.

2. The filter system of claim 1 wherein said container holding a large quantity of fluid is a high flow rate swimming pool.

3. The filter system of claim 1 wherein said sock filter is constructed of 100 percent polyester monofilament mesh, 300 threads per inch, tensile strength 30 Newtons/centimeters 45 micron opening size (aperture) opening percentage 30 percent/ratio of surface area.

4. The filter system of claims 1 and 3 wherein said sock filter periphery is reinforced by woven rayon binding.

5. The filter system of claims 1, 3 and 4 wherein said open top wall has 4 male metal snap fasteners positioned on opposite corners of said woven rayon binding for attachment to corresponding female snaps mounted on high flow rate laminar generator during filtering process.
